(19) United States
(12) Patent Application Publication
(10) Pub. No.: US 2019/0143582 A1
(43) Pub. Date: May 16, 2019

(54) COPOLYCARBONATE AS A SUPPORTING MATERIAL IN 3-D PRINTING

(71) Applicant: Covestro Deutschland AG, Leverkusen (DE)

(72) Inventors: Tim HUNGERLAND, Köln (DE); Matthias ROTHE, Leverkusen (DE); Rolf WEHRMANN, Krefeld (DE); Klaus HORN, Dormagen (DE); Christopher SCHIRWITZ, Leverkusen (DE); Tanja CASSEL, Duisburg (DE)

(73) Assignee: Covestro Deutschland AG, Leverkusen (DE)

(21) Appl. No.: 16/098,014

(22) PCT Filed: May 3, 2017
(86) PCT No.: PCT/EP2017/060453

§ 371 Date: Oct. 31, 2018

(30) Foreign Application Priority Data
May 4, 2016 (EP) 16168220.8

(51) Int. Cl. B29C 64/106; B29C 64/40; C08G 64/12; C08G 64/08; C08G 77/04

(52) U.S. Cl. CPC B29C 64/106; B29C 64/40; B33Y 10/00; C08G 64/085; C08G 77/04; C08G 64/12

(57) ABSTRACT

The invention relates to the use of copolycarbonates stable at high temperature as a supporting material in the FDM (fused deposition modeling) method, said copolycarbonates having a Vicat temperature determined in accordance with ISO 306:2013 of at least 150° C. Polyester, polyamide, PC/polyester blend, and/or polyaryl ether ketone is used as a printing material. Used as copolycarbonates are copolycarbonates containing one or more monomer units selected from the group consisting of the structural units of general formulas (1a), (1b), (1c), (1d), in which R¹ represents hydrogen or C₁ to C₄ alkyl, R² represents C₁ to C₄ alkyl, n represents 0, 1, 2, or 3, and R³ represents C₁ to C₄ alkyl, aralkyl, or aryl, and/or containing one or more monomer units of formula (1e), in which R¹⁹ represents hydrogen, Cl, Br, or a C₁ to C₄ alkyl residue, R¹⁷ and R¹⁸ are the same or different and represent, independently of each other, an aryl residue, a C₁ to C₁₀ alkyl residue, or a C₁ to C₁₀ alkylaryl residue, and wherein X is a single bond, —CO—, —O—, a C₁ to C₆ alkylene residue, a C₂ to C₅ alkylidene residue, a C₅ to C₁₂ cycloalkylidene residue, or a C₆ to C₁₂ arylene residue, which optionally can be condensed with further aromatic rings that contain heteroatoms, n is a number from 1 to 500, m is a number from 1 to 10, and p is 0 or 1.

The present invention relates to a process for producing a three-dimensional target object by means of fused deposition modeling using a support material, and to a shaped article having a multitude of layers of support material and a multitude of layers of print material.

In fused deposition modeling (FDM), also fused filament fabrication (FFF), a method from the field of rapid prototyping, a three-dimensional (3D) object is built up layer by layer from a fusible plastic. Typically, a 3D printer is used for this purpose. The object is printed layer by layer. First of all, a pattern of dots of the molten material is plotted on a surface. The molten print material which is typically used in filament form is generally plotted by extrusion by means of a nozzle, followed by hardening of the material by cooling at the desired position. Typically, first of all, the first layer is applied here as in a conventional 2D printing method by applying the layer to be applied line by line. Subsequently, the next layer is applied in an analogous manner.

A shaped article to be realized by means of 3D printing, i.e. the target object, may have geometries, for example undercuts, overhangs and any desired freeform surfaces. These geometrically critical structures cannot be realized easily by the printing of the building material, also called print material, but entail the use of what is called support material. While the print material serves to form the target object, the support material serves for mechanical reinforcement, i.e. stabilization of self-supporting surfaces and structures as shaped parts of the component through formation of support structures. The support material is printed as well in the construction of the actual three-dimensional object and has to be removed again after the printing. It is of course necessary here for the support material to be detachable from the 3D object without damaging it. In principle, there are two known methods for this purpose: mechanical removal and dissolution of the support material.

Mechanical removal is effected by cautious mechanical breakup, optionally with the aid of tools.

The dissolution of the support material is the gentler method. A suitable solvent has to be used to dissolve the support material. In this way, it is possible to free even sites of the component that are difficult to access of support material. Compared to mechanical detachment of the support material, smoother objects with sharper and finer edges are obtained. The support material can be removed completely by means of solvent in the detachment. The removal of the support material can be conducted in a simpler manner and within a shorter time. Laborious mechanical detachment operations are superfluous. It is additionally possible to implement an automated process in which the 3D object is first manufactured using print material and support material and the support material can then be removed from the target object in the solvent.

However, the search for suitable support materials that are suitable for removal by means of dissolution is found to be difficult given the innumerable volume of already known materials, since various demands have to be fulfilled with regard to suitability as material to be printed and also as material to be detached from the print material by means of solvent. The support material should have a high melting temperature similar to that of the print material. In the case of too high a difference between the melting temperatures, the material having the lower melting temperature that has already been printed on would otherwise partly melt again. As a result, the adhesion of the support material to the print material in the printed object from which the support material is to be removed could be too great. The properties of the print material could also be adversely affected. The shrinkage of the two materials should be comparable.

For the detachment of the support material, it is firstly crucial that the support material to be detached has good solubility in the envisaged solvent. Residue-free removal of the solvent leads to optimal results. The support material must be partly dissolvable at least to such an extent that detachment from the print material used is possible, but the print material used must not itself be attacked by the solvent. The condition of the printed print material, especially with regard to the geometry present and also the surface characteristics, should be conserved. If the support material is dissolved or detached, but the print material is simultaneously partly dissolved or swollen or undergoes an increase in haze or a color change, for example through formation of white streaks, there is an unsuitable combination of print material, support material and solvent.

The print materials used in the FDM method are typically moldable waxes and thermoplastics, e.g. polyethylene (PE), polypropylene (PP), polylactide (PLA), acrylonitrile-butadiene-styrene (ABS), glycol-modified polyethylene terephthalate (PETG) or else thermoplastic elastomers.

For thermoplastics having low melting temperatures, e.g. PLA (150-190° C.), to moderate melting temperatures, e.g. ABS (210-240° C.), as print materials, suitable soluble support materials have already been identified, for instance high-impact polystyrene (HIPS) or polyvinyl alcohol (PVA). Generally, the processing temperature of the filaments chosen should be much higher than the melting temperature thereof. For PLA, for example, nozzle temperatures of 180-210° C. are advisable.

For polymers having a higher melting or processing temperature in FDM printing, for example thermoplastic polyetheretherketone (PEEK), polyetherimide (PEI), polyamides (PA), polybutylene terephthalate (PBT), polyethylene terephthalate (PET) or else polycarbonate/polybutylene terephthalate blends (PC/PBT), only a few suitable support materials have been identified to date, and these additionally have various disadvantages. Support materials suitable for print materials having low melting temperatures are unsuitable for those having high melting temperatures since the already printed support material would melt again on printing of the print material.

Polymers having a higher melting or processing temperature are already been used as support materials in 3D printing, for instance polyetheretherketone (PEEK), polyethersulfone (PES), available, for example, under the Ultem name from Stratasys, or polyetherimide; however, these materials have to be removed mechanically.

In addition, soluble support materials are known.

For instance, US 2013/317164 A1 describes maleic anhydride copolymers as support material. This support material is soluble in alkaline aqueous solution. However, owing to its processing temperature, the support material described here is suitable only for printing with ABS. In general, the processing temperatures of print material and support material should not differ too significantly from one another, or there should at least be good thermal stability of the two materials.

US 2015/028523 A1 describes polyglycolic acid as support material with an HDT-A of 168° C. and a melting temperature of 220° C. This support material is printed in combination with a polysulfone as print material which has an HDT-A of 174° C., a glass transition temperature Tg of 185° C. and a melting temperature of 420° C. However, it is stated that higher temperatures than 300-330° C. already destroy the support material. Moreover, removal of the support material with alkaline aqueous solution is required.

Another support material of high thermal stability, known from WO 2015/175682 A1, is a carboxylic acid-functionalized copolymer, but this can likewise be dissolved only in alkaline aqueous solution.

In addition, there is also a known water-soluble support material, polyvinyl alcohol (Tg=85° C.) from 3D Systems, which according to the manufacturer is only compatible with nylon and PLA. However, the high tendency to absorb water/moisture in the case of water-soluble materials is also disadvantageous since storage of such materials with exclusion of moisture and sufficient drying prior to printing are necessary.

The soluble support materials known from the prior art are typically unstable over a long period at high temperature and/or require removal in alkaline aqueous solution, which attacks many polymers that are suitable in principle as print materials.

The problem addressed was therefore that of finding a support material which is stable even at particularly high processing temperatures of ≥250° C., preferably ≥300° C., especially ≥330° C., such that it can be used with print materials having a particularly high processing temperature, for example with PEEK having a processing temperature of 370-400° C., which results in 3D objects having high heat distortion resistance, and which can be removed by dissolution, possibly with a different solvent than an aqueous alkaline solution.

It has now been found that, surprisingly, compositions based on copolycarbonate of high thermal stability are suitable for use as support material in 3D printing (FDM), especially in combination with the aforementioned print materials having high melting or processing temperatures, i.e. ≥250° C., preferably ≥300° C., especially ≥330° C. According to the invention, “high thermal stability” is understood to mean a copolycarbonate having a Vicat temperature (VST/B 120; ISO 306:2013) of at least 150° C., preferably of more than 150° C., further preferably of at least 175° C., even further preferably of at least 180° C., more preferably of at least 200° C., preferably up to 230° C.

A corresponding copolycarbonate is available, for example, under the “APEC®” name from Covestro Deutschland AG. This is a copolycarbonate containing one or more monomer units of the formula (1a)

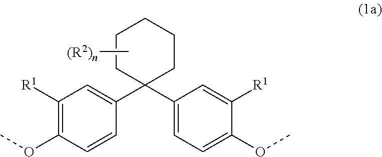

in which
R¹ is hydrogen or a C₁- to C₄-alkyl radical, preferably hydrogen,
R² is a C₁- to C₄-alkyl radical, preferably methyl radical,
n is 0, 1, 2 or 3, preferably 3.

An alternative copolycarbonate is one containing one or more monomer units of the formulae (1b), (1c), (1d) and/or (1e), which are shown below.

However, the copolycarbonate preferably contains monomer units of the general formula (1a).

The invention therefore provides a process for producing a three-dimensional object by means of fused deposition modeling using a support material, characterized in that the support material used is a composition based on a copolycarbonate having a Vicat temperature (VST/B 120), determined according to ISO 306:2013, of at least 150° C., preferably of more than 150° C., further preferably of at least 175° C.,

especially a copolycarbonate containing
one or more monomer units selected from the group consisting of the structural units of the general formulae (1a), (1b), (1c), (1d)

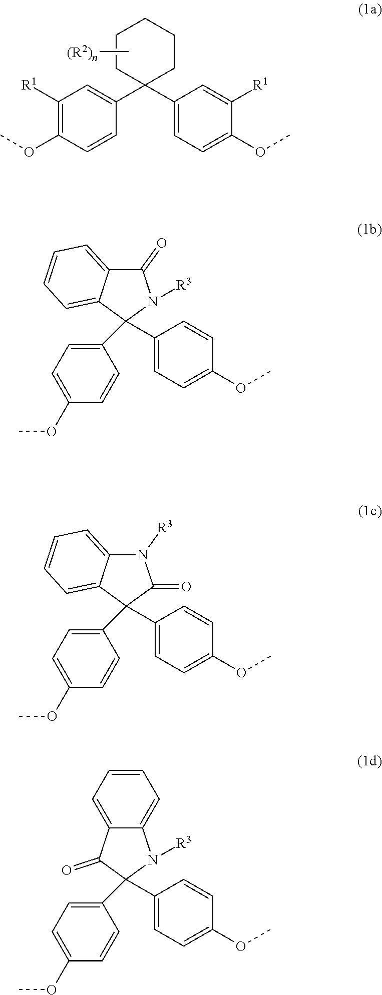

in which
R¹ is hydrogen or a C₁- to C₄-alkyl radical, preferably hydrogen,
R² is a C₁- to C₄-alkyl radical, preferably methyl radical,
n is 0, 1, 2 or 3, preferably 3, and
R³ is a C₁- to C₄-alkyl radical, aralkyl radical or aryl radical, preferably a methyl radical or phenyl radical, most preferably a methyl radical,
and/or
one or more monomer units of a siloxane of the general formula (1e)

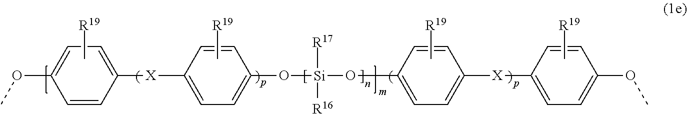

in which
R¹⁹ is hydrogen, Cl, Br or a C₁- to C₄-alkyl radical, preferably hydrogen or a methyl radical, more preferably hydrogen,
R¹⁷ and R¹⁸ are the same or different and are each independently an aryl radical, a C₁- to C₁₀-alkyl radical or a C₁- to C₁₀-alkylaryl radical, preferably each a methyl radical, and where
X is a single bond, —CO—, —O—, a C₁- to C₆-alkylene radical, a C₂- to C₅-alkylidene radical, a C₅- to C₁₂-cycloalkylidene radical or a C₆- to C₁₂-arylene radical which may optionally be fused to further aromatic rings containing heteroatoms, where X is preferably a single bond, a C₁- to C₅-alkylene radical, a C₂- to C₅-alkylidene radical, a C₅- to C₁₂-cycloalkylidene radical, —O— or —CO—, further preferably a single bond, an isopropylidene radical, a C₅- to C₁₂-cycloalkylidene radical or —O—, most preferably an isopropylidene radical,
n is a number from 1 to 500, preferably from 10 to 400, more preferably from 10 to 100, most preferably from 20 to 60,
m is a number from 1 to 10, preferably from 1 to 6, more preferably from 2 to 5,
p is 0 or 1, preferably 1,
and the value of n×m is preferably between 12 and 400, further preferably between 15 and 200,
where the siloxane is preferably reacted with a polycarbonate in the presence of an organic or inorganic salt of a weak acid having a pK_{A} of 3 to 7 (25° C.),
and the print material used is a polyester, a polyamide, a PC/polyester blend and/or a polyaryl ether ketone.

If a copolycarbonate having monomer units of the formula (1b), (1c), (1d) and/or (1e) is used, the solvent used to remove the support material is THF (tetrahydrofuran), alone or in a mixture. This is also applicable if the copolycarbonate contains monomer units of the formula (1a) and the Vicat temperature (VST/B120), determined according to ISO 306:2013, is below 175° C.

Copolycarbonates having monomer units of the formula (1e) and especially also the preparation thereof are described in WO 2015/052106 A2.

According to the invention, polycarbonates and copolycarbonates are especially understood to mean aromatic polycarbonates or copolycarbonates.

C₁- to C₄-Alkyl in the context of the invention is, for example, methyl, ethyl, n-propyl, isopropyl, n-butyl, sec-butyl, tert-butyl, C₁- to C₅-alkyl is also, for example, n-pentyl, I-methylbutyl, 2-methylbutyl, 3-methylbutyl, neopentyl, 1-ethylpropyl, cyclohexyl, cyclopentyl, n-hexyl, 1,1-dimethylpropyl, 1,2-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, i-ethylbutyl, 2-ethylbutyl, 1,1,2-trimethylpropyl, 1,2,2-trimethylpropyl, 1-ethyl-1-methylpropyl, 1-ethyl-2-methylpropyl or 1-ethyl-2-methylpropyl, C₁- to C₁₀-alkyl is also, for example, n-heptyl and n-octyl, pinacyl, adamantyl, the isomeric menthyls, n-nonyl, n-decyl, and C₁- to C₃₄-alkyl is also, for example, n-dodecyl, n-tridecyl, n-tetradecyl, n-hexadecyl or n-octadecyl. The same applies to the corresponding alkyl radical, for example in aralkyl/alkylaryl, alkylphenyl or alkylcarbonyl radicals. Alkylene radicals in the corresponding hydroxyalkyl or aralkyl/alkylaryl radicals are for example the alkylene radicals corresponding to the preceding alkyl radicals.

Aryl radical is a carbocyclic aromatic radical having 6 to 34 skeletal carbon atoms. The same applies to the aromatic moiety of an arylalkyl radical, also known as an aralkyl radical, and to aryl constituents of more complex groups, for example arylcarbonyl radicals.

Examples of C₅- to C₃₄-aryl are phenyl, o-, p-, m-tolyl, naphthyl, phenanthrenyl, anthracenyl and fluorenyl.

Arylalkyl and aralkyl are each independently a straight-chain, cyclic, branched or unbranched alkyl radical as defined above, which may be mono-, poly- or persubstituted by aryl radicals as defined above.

The above lists are illustrative and should not be regarded as limiting.

“Compositions based on copolycarbonate” in the context of the present invention are understood to mean those compositions that contain at least 50% by weight of copolycarbonate, preferably at least 60% by weight, more preferably at least 75% by weight, most preferably at least 85% by weight, of copolycarbonate. This is also understood to mean the copolycarbonates without further additives. With regard to the additives that may be present in the compositions based on copolycarbonate, the same applies as described later on for the print material compositions.

The monomer unit(s) of general formula (1a) is/are introduced via one or more corresponding diphenols of general formula (1a′):

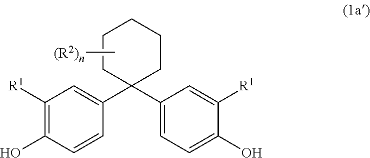

in which
R¹ is hydrogen or a C₁- to C₄-alkyl radical, preferably hydrogen,
R² is a C₁- to C₄-alkyl radical, preferably a methyl radical, and
n is 0, 1, 2 or 3, preferably 3.

The diphenols of the formula (1a′) and the use thereof in homopolycarbonates are disclosed in the literature (DE 3918406 A1).

Particular preference is given to 1,1-bis(4-hydroxyphenyl)-3,3,5-trimethylcyclohexane (bisphenol TMC) having the formula (1a″):

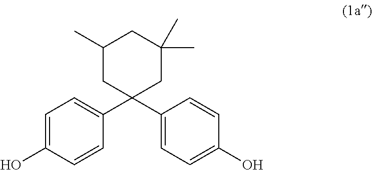 [SMILES: CC1CC(C)(C)CC(c2ccc(O)cc2)(c2ccc(O)cc2)C1]

The copolycarbonates having monomer units of the general formulae (1b), (1c) and/or (1d) have high heat distortion resistance and low thermal shrinkage. The Vicat temperature in the case of copolycarbonates used in accordance with the invention is typically between 175° C. and 230° C.

The monomer unit(s) of general formula (1b), (1c) and/or (1d) are introduced via one or more corresponding diphenols of general formulae (1 b′), (1c′) and (1 d′):

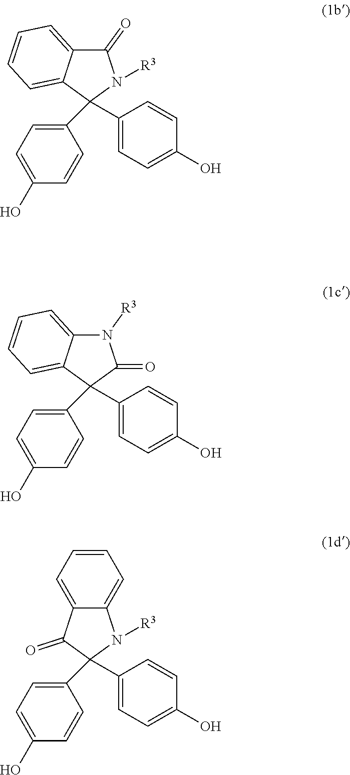

in which R³ is a C₁- to C₄-alkyl radical, aralkyl radical or aryl radical, preferably a methyl radical or phenyl radical, most preferably a methyl radical.

As well as one or more monomer units of the formula (1a), (1b), (1c), (1d) and/or (1e), the copolycarbonates used as support material in accordance with the invention may have one or more monomer unit(s) of the formula (2):

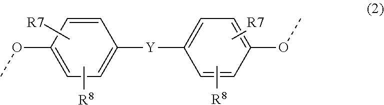

in which
R⁷ and R⁸ are independently H, a C₁- to C₁₈-alkyl radical, a C₁- to C₁₈-alkoxy radical, halogen such as Cl or Br or are each an optionally substituted aryl radical or aralkyl radical, preferably H or a C₁- to C₁₂-alkyl radical, more preferably H or a C₁- to C₈-alkyl radical and most preferably H or a methyl radical, and
Y is a single bond, —SO₂—, —CO—, —O—, —S—, a C₁- to C₆-alkylene radical or C₂- to C₅-alkylidene radical, or else a C₆- to C₁₂-arylene radical which may optionally be fused to further aromatic rings containing heteroatoms.

The monomer unit(s) of general formula (2) is/are introduced via one or more corresponding diphenols of general formula (2a):

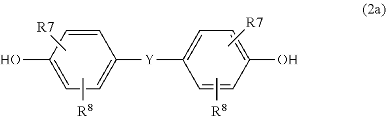

where R⁷, R⁸ and Y are each as already defined in connection with formula (2).

Examples of the diphenols of formula (2a) which may be used in addition to the diphenols of formula (1a′), (1b′), (1c′) and/or (1d) include hydroquinone, resorcinol, dihydroxybiphenyls, bis(hydroxyphenyl)alkanes, bis(hydroxyphenyl)sulfides, bis(hydroxyphenyl) ethers, bis(hydroxyphenyl) ketones, bis(hydroxyphenyl) sulfones, bis(hydroxyphenyl)sulfoxides, α,α′-bis(hydroxyphenyl)diisopropylbenzenes and the ring-alkylated and ring-halogenated compounds thereof and also α,ω-bis(hydroxyphenyl)polysiloxanes.

Preferred diphenols of formula (2a) are for example 4,4′-dihydroxybiphenyl (DOD), 4,4′-dihydroxybiphenyl ether (DOD ether), 2,2-bis(4-hydroxyphenyl)propane (bisphenol A), 2,4-bis(4-hydroxyphenyl)-2-methylbutane, 1,1-bis(4-hydroxyphenyl)-1-phenylethane, 1,1-bis[2-(4-hydroxyphenyl)-2-propyl]benzene, 1,3-bis[2-(4-hydroxyphenyl)-2-propyl]benzene (bisphenol M), 2,2-bis(3-methyl-4-hydroxyphenyl)propane, 2,2-bis(3-chloro-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 2,2-bis(3,5-dichloro-4-hydroxyphenyl)propane and 2,2-bis(3,5-dibromo-4-hydroxyphenyl)propane.

Particularly preferred diphenols are for example 2,2-bis(4-hydroxyphenyl)propane (bisphenol A), 4,4′-dihydroxybiphenyl (DOD), 4,4′-dihydroxybiphenyl ether (DOD ether), 1,3-bis[2-(4-hydroxyphenyl)-2-propyl]benzene (bisphenol M), 2,2-bis(3,5-dimethyl-4-hydroxyphenyl)propane, 1,1-bis(4-hydroxyphenyl)-1-phenylethane, 2,2-bis(3,5-dichloro-4-hydroxyphenyl)propane and 2,2-bis(3,5-dibromo-4-hydroxyphenyl)propane.

Very particular preference is given to compounds of general formula (2b),

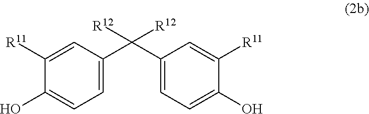

in which
R¹¹ is H, linear or branched C₁- to C₁₀-alkyl radicals, preferably linear or branched C₁- to C₆-alkyl radicals, more preferably linear or branched C₁- to C₄-alkyl radicals, most preferably H or a C₁-alkyl radical (methyl radical), and
R¹² is linear or branched C₁- to C₁₀-alkyl radicals, preferably linear or branched C₁- to C₆-alkyl radicals, more preferably linear or branched C₁- to C₄-alkyl radicals, most preferably a C₁-alkyl radical (methyl radical).

Diphenol (2c) in particular is very particularly preferred here.

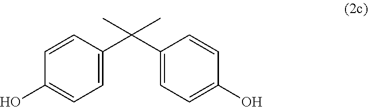 [SMILES: CC(C)(c1ccc(O)cc1)c1ccc(O)cc1]

The diphenols of the general formula (2a) may be used either alone or else in admixture with one another. The diphenols are known from the literature or preparable by literature methods (see for example H. J. Buysch et al., Ullmann's Encyclopedia of Industrial Chemistry, VCH, New York 1991, 5th ed., vol. 19, p. 348).

The total proportion of the monomer units of formulae (1a), (1b), (1c) and (1d) in the copolycarbonate is preferably 0.1-88 mol %, more preferably 1-86 mol %, even more preferably 5-84 mol % and especially 10-82 mol % (based on the sum of the moles of diphenols used).

Preferably, the diphenoxide units of the copolycarbonates of component A derive from monomers having the general structures of the above-described formulae (1a), further preferably (1a″), and (2a), most preferably (2c).

In another preferred embodiment of the composition according to the invention, the diphenoxide units of the copolycarbonates of component A derive from monomers having the general structures of the above-described formulae (2a) and (1b′), (1c′) and/or (1d′).

A preferred copolycarbonate is formed from 17% to 62% by weight of bisphenol A and 38% to 83% by weight, further preferably 50% to 70% by weight, of comonomer of the general formula (1b), (1c) and/or (1d), where the amounts of bisphenol A and comonomer of the general formulae (1b), (1c) and/or (1d) add up to 100% by weight.

The proportion of monomer units of the formula (1a), preferably of bisphenol TMC, in the copolycarbonate is preferably 10-95% by weight, further preferably 30% to 85% by weight, more preferably 30% to 67% by weight. In the case of 30% by weight or more of bisphenol TMC, the Vicat temperature (VST/B 120; ISO 306:2013) of the copolycarbonate is more than 175° C. The monomer of the formula (2) used here is preferably bisphenol A, the proportion of which is preferably 15% to 56% by weight. More preferably, the copolycarbonate is formed from the monomers bisphenol TMC and bisphenol A.

The copolycarbonates used as support material in accordance with the invention preferably have a Vicat softening temperature, determined according to ISO 306:2013, of 150 to 230° C., preferably of 155 to 225° C., even further preferably of 160° C. to 220° C., more preferably 175° C. to 220° C., most preferably of 180° C. to 218° C.

The copolycarbonates may be in the form of block and random copolycarbonate. Particular preference is given to random copolycarbonates.

The ratio of the frequency of the diphenoxide monomer units in the copolycarbonate is calculated here from the molar ratio of the diphenols used.

The relative solution viscosity of the copolycarbonates, determined to ISO 1628-4:1999, is preferably in the range of 1.15-1.35.

The weight-average molar masses Mw of the copolycarbonates are preferably 15 000 to 40 000 g/mol, more preferably 17 000 to 36 000 g/mol, most preferably 17 000 to 34 000 g/mol, and are determined by means of GPC in methylene chloride against polycarbonate calibration.

### Preparation Process

Preferred preparation processes for the copolycarbonates are the interfacial process and the melt transesterification process. In a preferred embodiment, preparation is effected by the melt transesterification process.

To obtain copolycarbonates of high molecular weight by the interfacial process, the alkali metal salts of diphenols are reacted with phosgene in a biphasic mixture. The molecular weight can be controlled via the amount of monophenols which act as chain terminators, for example phenol, tert-butylphenol or cumylphenol, more preferably phenol, tert-butylphenol. These reactions form virtually exclusively linear polymers. This can be confirmed by end-group analysis. Through specific use of what are called branching agents, generally polyhydroxylated compounds, branched polycarbonates are also obtained here.

Branching agents used may be small amounts, preferably amounts between 0.05 and 5 mol %, more preferably 0.1-3 mol %, most preferably 0.1-2 mol %, based on the moles of diphenols used, of trifunctional compounds such as, for example, isatin biscresol (IBC) or phloroglucinol, 4,6-dimethyl-2,4,6-tri(4-hydroxyphenyl)hept-2-ene; 4,6-dimethyl-2,4,6-tri(4-hydroxyphenyl)heptane; 1,3,5-tri(4-hydroxyphenyl)benzene; 1,1,1-tri(4-hydroxyphenyl)ethane (THPE); tri(4-hydroxyphenyl)phenylmethane; 2,2-bis[4,4-bis(4-hydroxyphenyl)cyclohexyl]propane; 2,4-bis(4-hydroxyphenylisopropyl)phenol; 2,6-bis(2-hydroxy-5′-methylbenzyl)-4-methylphenol; 2-(4-hydroxyphenyl)-2-(2,4-dihydroxyphenyl)propane; hexa(4-(4-hydroxyphenylisopropyl)phenyl) orthoterephthalate; tetra(4-hydroxyphenyl)methane; tetra(4-(4-hydroxyphenylisopropyl)phenoxy)methane; α,α′,α″-tris(4-hydroxyphenyl)-1,3,5-triisopropylbenzene; 2,4-dihydroxybenzoic acid; trimesic acid; cyanuric chloride; 3,3-bis(3-methyl-4-hydroxyphenyl)-2-oxo-2,3-dihydroindole; 1,4-bis(4′,4″-dihydroxytriphenyl)methyl)benzene and in particular 1,1,1-tri(4-hydroxyphenyl)ethane (THPE) and bis(3-methyl-4-hydroxyphenyl)-2-oxo-2,3-dihydroindole. Preference is given to using isatin biscresol and also 1,1,1-tri(4-hydroxyphenyl)ethane (THPE) and bis(3-methyl-4-hydroxyphenyl)-2-oxo-2,3-dihydroindole.

The use of these branching agents results in branched structures. The resulting long-chain branching generally leads to structural viscosity by comparison with linear types.

The amount of chain terminator to be used is preferably 0.5 mol % to 10 mol %, preferably 1 mol % to 8 mol %, more preferably 2 mol % to 6 mol %, based on the moles of diphenols used in each case. The chain terminators can be added before, during or after the phosgenation, preferably as a solution in a solvent mixture of methylene chloride and chlorobenzene (8-15 percent strength by weight).

To obtain copolycarbonates of high molecular weight by the melt transesterification process, diphenols are reacted in the melt with carbonic diesters, usually diphenyl carbonate, in the presence of catalysts, such as alkali metal salts, ammonium or phosphonium compounds, and optionally further additives.

The melt transesterification process is described for example in Encyclopedia of Polymer Science, Vol. 10 (1969), Chemistry and Physics of Polycarbonates, Polymer Reviews, H. Schnell, Vol. 9, John Wiley and Sons, Inc. (1964) and in DE-C 10 31 512.

Carbonic diesters for the purposes of the invention are those of formulae (5) and (6)

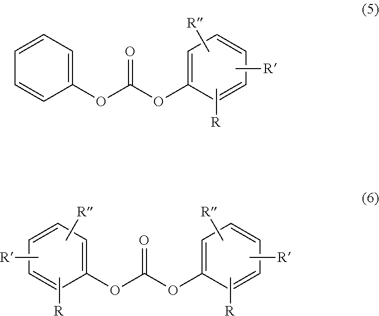

where
R, R′ and R″ may independently represent H, optionally branched C₁- to C₃₄-alkyl/cycloalkyl radicals, C₇- to C₃₄-alkaryl radicals or C₆- to C₃₄-aryl radicals,
for example
diphenyl carbonate, butylphenyl phenyl carbonate, di(butylphenyl) carbonate, isobutylphenyl phenyl carbonate, di(isobutylphenyl) carbonate, tert-butylphenyl phenyl carbonate, di(tert-butylphenyl) carbonate, n-pentylphenyl phenyl carbonate, di(n-pentylphenyl) carbonate, n-hexylphenyl phenyl carbonate, di(n-hexylphenyl) carbonate, cyclohexylphenyl phenyl carbonate, di(cyclohexylphenyl) carbonate, phenylphenol phenyl carbonate, di(phenylphenol) carbonate, isooctylphenyl phenyl carbonate, di(isooctylphenyl) carbonate, n-nonylphenyl phenyl carbonate, di(n-nonylphenyl) carbonate, cumylphenyl phenyl carbonate, di(cumylphenyl) carbonate, naphthylphenyl phenyl carbonate, di(naphthylphenyl) carbonate, di-tert-butylphenyl phenyl carbonate, di(di-tert-butylphenyl) carbonate, dicumylphenyl phenyl carbonate, di(dicumylphenyl) carbonate, 4-phenoxyphenyl phenyl carbonate, di(4-phenoxyphenyl) carbonate, 3-pentadecylphenyl phenyl carbonate, di(3-pentadecylphenyl) carbonate, tritylphenyl phenyl carbonate, di(tritylphenyl) carbonate,
preferably diphenyl carbonate, tert-butylphenyl phenyl carbonate, di-(tert-butylphenyl) carbonate, phenylphenol phenyl carbonate, di(phenylphenol) carbonate, cumylphenyl phenyl carbonate, di(cumylphenyl) carbonate, more preferably diphenyl carbonate. It is also possible to use mixtures of the carbonic diesters mentioned.

The proportion of carbonic esters is 100 to 130 mol %, preferably 103 to 120 mol %, more preferably 103 to 109 mol %, based on the one or more diphenols.

As described in the literature cited, catalysts used in the melt transesterification process are basic catalysts, for example alkali metal and alkaline earth metal hydroxides and oxides, but also ammonium or phosphonium salts referred to hereinafter as onium salts. Preference is given to using onium salts, more preferably phosphonium salts. Phosphonium salts in the context of the invention are those having the following general formula (7):

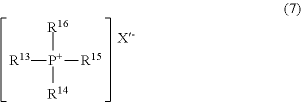

where
R¹³⁻¹⁶ may be the same or different C₁- to C₁₀-alkyl radicals, C₆- to C₁₀-aryl radicals, C₇- to C₁₀-aralkyl radicals or C₅- to C₆-cycloalkyl radicals, preferably methyl radical or C₆- to C₁₄-aryl radical, more preferably a methyl radical or phenyl radical, and
X′⁻ may be an anion such as hydroxide, sulfate, hydrogensulfate, hydrogencarbonate, carbonate, a halide, preferably chloride, or an alkoxide of formula OR¹⁷, wherein R¹⁷ may be a C₆- to C₁₄-aryl radical or C₇- to C₁₂-aralkyl radical, preferably phenyl radical.

Preferred catalysts are tetraphenylphosphonium chloride, tetraphenylphosphonium hydroxide, tetraphenylphosphonium phenoxide, more preferably tetraphenylphosphonium phenoxide.

The catalysts are preferably used in amounts of 10⁻⁸ to 10⁻³ mol, based on one mole of diphenol, more preferably in amounts of 10⁻⁷ to 10⁻⁴ mol.

Further catalysts may be used alone or optionally in addition to the onium salt to increase the rate of the polymerization. These include salts of alkali metals and alkaline earth metals, such as hydroxides, alkoxides and aryloxides of lithium, sodium and potassium, preferably hydroxide, alkoxide or aryloxide salts of sodium. Greatest preference is given to sodium hydroxide and sodium phenoxide. The amounts of the cocatalyst may be in the range from 1 to 200 ppb, preferably 5 to 150 ppb and most preferably 10 to 125 ppb, calculated in each case as sodium.

The catalysts are added in solution in order to avoid deleterious overconcentrations during metering. The solvents are system- and process-inherent compounds, for example diphenol, carbonic diesters or monohydroxyaryl compounds. Particular preference is given to monohydroxyaryl compounds because it is familiar to one skilled in the art that the diphenols and carbonic diesters readily undergo transformation and decomposition even at only mildly elevated temperatures, especially under the action of catalysts. This adversely affects polycarbonate qualities. In the industrially important transesterification process for preparation of polycarbonate, the preferred compound is phenol. Phenol is also a compelling option because the tetraphenylphosphonium phenoxide catalyst used with preference is isolated as a cocrystal with phenol in the preparation.

The process for preparing the copolycarbonates by the transesterification process may have a batchwise or else continuous configuration. Once the diphenols and carbonic diesters are in the form of a melt, optionally with further compounds, the reaction is initiated in the presence of the catalyst. The conversion/the molecular weight is increased with rising temperatures and falling pressures in suitable apparatuses and devices by removing the eliminated monohydroxyaryl compound until the desired final state is achieved. Choice of the ratio of diphenol to carbonic diester and of the rate of loss of the carbonic diester via the vapors and of any added compounds, for example of a higher-boiling monohydroxyaryl compound, said rate of loss arising through choice of procedure/plant for producing the polycarbonate, is what decides the end groups in terms of their nature and concentration.

With regard to the manner in which, the plant in which and the procedure by which the process is executed, there is no limitation or restriction.

Moreover, there is no specific limitation and restriction with regard to the temperatures, the pressures and catalysts used, in order to perform the melt transesterification reaction between the diphenol and the carbonic diester, and any other reactants added. Any conditions are possible, provided that the temperatures, pressures and catalysts chosen enable a melt transesterification with correspondingly rapid removal of the eliminated monohydroxyaryl compound.

The temperatures over the entire process are generally 180 to 330° C. at pressures of 15 bar absolute to 0.01 mbar absolute.

It is normally a continuous procedure that is chosen, because this is advantageous for product quality.

Preferably, the continuous process for producing polycarbonates is characterized in that one or more diphenols with the carbonic diester, also any other reactants added, using the catalysts, after a precondensation, without removing the monohydroxyaryl compound formed, in several reaction evaporator stages which then follow at temperatures rising stepwise and pressures falling stepwise, the molecular weight is increased to the desired level.

The devices, apparatuses and reactors that are suitable for the individual reaction evaporator stages are, in accordance with the process sequence, heat exchangers, flash apparatuses, separators, columns, evaporators, stirred vessels and reactors or other purchasable apparatuses which provide the necessary residence time at selected temperatures and pressures. The devices chosen must enable the necessary input of heat and be constructed such that they are able to cope with the continuously increasing melt viscosities.

All devices are connected to one another by pumps, pipelines and valves. The pipelines between all the devices should of course be as short as possible and the curvature of the conduits should be kept as low as possible in order to avoid unnecessarily prolonged residence times. At the same time, the external, i.e. technical, boundary conditions and requirements for assemblies of chemical plants should be observed.

To perform the process by a preferred continuous procedure the coreactants can either be melted together or else the solid diphenol can be dissolved in the carbonic diester melt or the solid carbonic diester can be dissolved in the melt of the diphenol or both raw materials are combined in molten form, preferably directly from preparation. The residence times of the separate melts of the raw materials, in particular the residence time of the melt of the diphenol, are adjusted so as to be as short as possible. The melt mixture, by contrast, because of the depressed melting point of the raw material mixture compared to the individual raw materials, can reside for longer periods at correspondingly lower temperatures without loss of quality.

Thereafter, the catalyst, preferably dissolved in phenol, is mixed in and the melt is heated to the reaction temperature. At the start of the industrially important process for preparing polycarbonate from 2,2-bis(4-hydroxyphenyl)propane and diphenyl carbonate, this temperature is 180 to 220° C., preferably 190 to 210° C., most preferably 190° C. Over the course of residence times of 15 to 90 min, preferably 30 to 60 min, the reaction equilibrium is established without withdrawing the hydroxyaryl compound formed. The reaction can be run at atmospheric pressure, but for industrial reasons also at elevated pressure. The preferred pressure in industrial plants is 2 to 15 bar absolute.

The melt mixture is expanded into a first vacuum chamber, the pressure of which is set to 100 to 400 mbar, preferably to 150 to 300 mbar, and then heated directly back to the inlet temperature at the same pressure in a suitable device. In the expansion operation, the hydroxyaryl compound formed is evaporated together with monomers still present. After a residence time of 5 to 30 min in a bottoms reservoir, optionally with pumped circulation, at the same pressure and the same temperature, the reaction mixture is expanded into a second vacuum chamber, the pressure of which is 50 to 200 mbar, preferably 80 to 150 mbar, and directly afterwards heated in a suitable apparatus at the same pressure to a temperature of 190° C. to 250° C., preferably 210° C. to 240° C., more preferably 210° C. to 230° C. Here too, the hydroxyaryl compound formed is evaporated together with monomers still present. After a residence time of 5 to 30 min in a bottoms reservoir, optionally with pumped circulation, at the same pressure and the same temperature, the reaction mixture is expanded into a third vacuum chamber, the pressure of which is 30 to 150 mbar, preferably 50 to 120 mbar, and directly afterwards heated in a suitable apparatus at the same pressure to a temperature of 220° C. to 280° C., preferably 240° C. to 270° C., more preferably 240° C. to 260° C. Here too, the hydroxyaryl compound formed is evaporated together with monomers still present. After a residence time of 5 to 20 min in a bottoms reservoir, optionally with pumped circulation, at the same pressure and the same temperature, the reaction mixture is expanded into a further vacuum chamber, the pressure of which is 5 to 100 mbar, preferably 15 to 100 mbar, more preferably 20 to 80 mbar, and directly afterwards heated in a suitable apparatus at the same pressure to a temperature of 250° C. to 300° C., preferably 260° C. to 290° C., more preferably 260° C. to 280° C. Here too, the hydroxyaryl compound formed is evaporated together with monomers still present.

The number of these stages, 4 here by way of example, may vary between 2 and 6. The temperatures and pressures should be adjusted appropriately when the number of stages is altered in order to obtain comparable results. The relative viscosity of the oligomeric carbonate attained in these stages is between 1.04 and 1.20, preferably between 1.05 and 1.15, more preferably between 1.06 to 1.10.

The oligocarbonate thus obtained, after a residence time of 5 to 20 min in a bottoms reservoir, optionally with pumped circulation, at the same pressure and the same temperature as in the last flash/evaporator stage, is conveyed into a disk or cage reactor and subjected to further condensation at 250° C. to 310° C., preferably 250° C. to 290° C., more preferably 250° C. to 280° C., at pressures of 1 to 15 mbar, preferably 2 to 10 mbar, with residence times of 30 to 90 min, preferably 30 to 60 min. The product attains a relative viscosity of 1.12 to 1.28, preferably 1.13 to 1.26, more preferably 1.13 to 1.24.

The melt leaving this reactor is brought to the desired final viscosity/the final molecular weight in a further disk or cage reactor. The temperatures are 270° C. to 330° C., preferably 280° C. to 320° C., more preferably 280° C. to 310° C., and the pressure is 0.01 to 3 mbar, preferably 0.2 to 2 mbar, with residence times of 60 to 180 min, preferably 75 to 150 min. The relative viscosities are set to the level necessary for the application envisaged and are 1.18 to 1.40, preferably 1.18 to 1.36, more preferably 1.18 to 1.34.

The function of the two cage reactors or disk reactors can also be combined in one cage reactor or disk reactor.

The vapors from all the process stages are directly led off, collected and processed. This processing is generally effected by distillation in order to achieve high purities of the substances recovered. This can be effected, for example, according to German patent application no. 10 100 404. Recovery and isolation of the eliminated monohydroxyaryl compound in ultrapure form is an obvious aim from an economic and environmental point of view. The monohydroxyaryl compound can be used directly for producing a diphenol or a carbonic diester.

It is a feature of the disk or cage reactors that they provide a very large, constantly renewing surface under reduced pressure with high residence times. The disk or cage reactors have a geometric shape in accordance with the melt viscosities of the products. Suitable examples are reactors as described in DE 44 47 422 C2 and EP A 1 253 163 or twin-shaft reactors as described in WO A 99/28 370.

The finished polycarbonates are generally conveyed by means of gear pumps, screws of a wide variety of designs or positive displacement pumps of a specific design.

Analogously to the interfacial method, it is possible to use polyfunctional compounds as branching agents.

The preparation of polysiloxane-polycarbonate block copolymers via the interfacial process is also known from the literature and is described, for example, in U.S. Pat. Nos. 3,189,662, 3,419,634, DE-A 3 34 782 and EP 0 122 535. The same applies to the preparation by the melt transesterification process from bisphenol, diaryl carbonate, silanol end-terminated polysiloxanes and catalyst, described in U.S. Pat. No. 5,227,449.

In the process of the invention for production of three-dimensional target objects, the support material used is preferably a copolycarbonate formed from 1,1-bis(4-hydroxyphenyl)-3,3,5-trimethylcyclohexane (bisphenol TMC) and 2,2-bis(4-hydroxyphenyl)propane (bisphenol A).

The print materials used are a polyaryl ether ketone, especially PEEK, a polyester, especially PBT, a polyamide, especially PA-12, a PC/polyester blend, preferably PC/PBT, especially a PC/PBT blend having a polyester content of 15% to 70% by weight, more preferably 30% to 40% by weight, most preferably 30% to 35% by weight, and/or PET, more preferably PBT or a polyamide, the polyamide especially being PA-12.

“Used as print material” encompasses not just the use of the pure polymers as such but also that of polymer compositions containing one of these polymers as the predominant component. “Predominant” is understood here to mean those compositions containing at least 50% by weight of the aforementioned polymer, preferably at least 60% by weight, more preferably at least 75% by weight, most preferably at least 85% by weight, of the aforementioned polymer. Polymer compositions of this kind typically also contain customary additives.

Such additives as are typically added in polycarbonates are especially antioxidants, demolding agents, flame retardants, UV absorbers, IR absorbers, antistats, optical brighteners, light-scattering agents, impact modifiers, colorants such as organic or inorganic pigments, thermally conductive additives, thermal stabilizers and/or additives for laser marking in amounts customary for polycarbonate, such as those described, for example, in EP-A 0 839 623, WO-A 96/15102, EP-A 0 500 496 or “Plastics Additives Handbook”, Hans Zweifel, 5th Edition 2000, Hanser Verlag, Munich. These additives can be added singly or else in admixture.

The support materials used in accordance with the invention can be dissolved in aromatic hydrocarbons. Aromatic hydrocarbons of particularly good suitability are mono- and polymethylated aromatic hydrocarbons, for example toluene, xylene and/or mesitylene. It is also possible to use cyclic ethers, for example tetrahydrofuran (THF), to dissolve the support material. The support material can also be dissolved using solvent mixtures, for example a solvent mixture of 2.5% to 10% by weight of 1,3,5-trimethylbenzene, 0.5% to 2.5% by weight of cumene, 25% to 50% by weight of 2-methoxy-1-methylethyl acetate, 10% to 25% by weight of 1,2,4-trimethylbenzene, <0.5% by weight of 2-methoxypropyl acetate, 25% to 50% by weight of ethyl 3-ethoxypropionate and 10% to 25% by weight of naphtha; or generally solvents from the group of the aromatic hydrocarbons.

In combination with the aforementioned support materials used with preference and the aforementioned print materials used with preference, the support material is preferably dissolved using tetrahydrofuran, xylene, mesitylene, cumene, benzene, toluene, dioxane or tetrahydropyran, further preferably tetrahydrofuran or xylene, most preferably tetrahydrofuran.

The support material is preferably dissolved at elevated temperature relative to room temperature.

The support material is preferably dissolved under the action of ultrasound, since this accelerates the dissolution process. Preference is given to using a combination of ultrasound and elevated temperature.

As well as the process of the invention, the invention also provides a shaped article having

a) a multitude of layers comprising copolycarbonate, comprising
one or more monomer units of the formulae (1a), (1b), (1c), (1d)

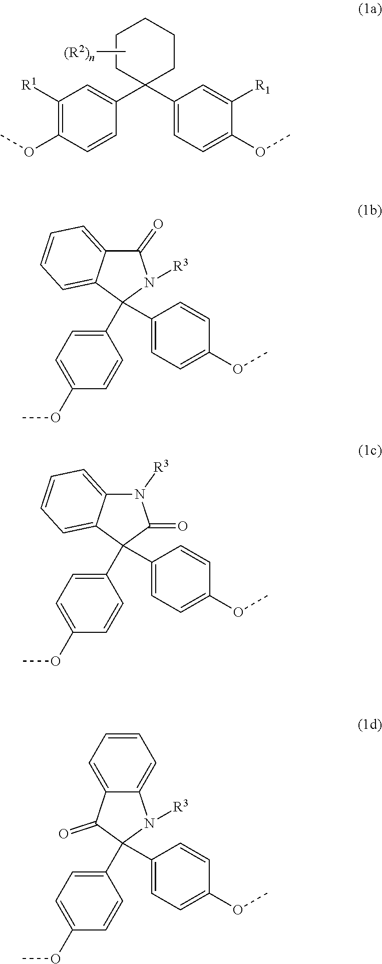

in which
R¹ is hydrogen or a C₁- to C₄-alkyl radical, preferably hydrogen,
R² is a C₁- to C₄-alkyl radical, preferably methyl radical,
n is 0, 1, 2 or 3, preferably 3,
R³ is a C₁- to C₄-alkyl radical, aralkyl radical or aryl radical, preferably a methyl radical or phenyl radical, most preferably a methyl radical,
and/or of the formula (1e)

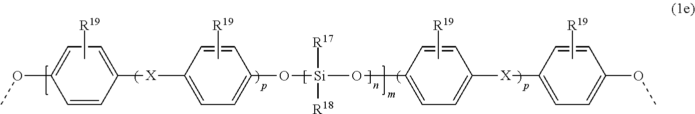

in which
   R¹⁹ is hydrogen, Cl, Br or a C₁- to C₄-alkyl radical, preferably hydrogen or a methyl radical, and more preferably hydrogen,
   R¹⁷ and R¹⁸ are the same or different and are each independently an aryl radical, a C₁- to C₁₀-alkyl radical or a C₁- to C₁₀-alkylaryl radical, preferably each a methyl radical, and where
   X is a single bond, —CO—, —O—, a C₁- to C₆-alkylene radical, a C₂- to C₅-alkylidene radical, a C₅- to C₁₂-cycloalkylidene radical or a C₆- to C₁₂-arylene radical which may optionally be fused to further aromatic rings containing heteroatoms, where X is preferably a single bond, a C₁- to C₅-alkylene radical, a C₂- to C₅-alkylidene radical, a C₅- to C₁₂-cycloalkylidene radical, —O— or —CO—, further preferably a single bond, an isopropylidene radical, a C₅- to C₁₂-cycloalkylidene radical or —O—, most preferably an isopropylidene radical,
   n is a number from 1 to 500, preferably from 10 to 400, more preferably from 10 to 100, most preferably from 20 to 60,
   m is a number from 1 to 10, preferably from 1 to 6, more preferably from 2 to 5,
   p is 0 or 1, preferably 1,
   and the value of n×m is preferably between 12 and 400, further preferably between 15 and 200,
   and
   b) a multitude of layers, comprising a polyaryl ether ketone, especially PEEK, a polyester, especially PBT or PET, a polyamide, especially PA-12, and/or a PC/polyester blend, especially PC/PBT,
   where the Vicat temperature (VST/B120) of the copolycarbonate, determined according to ISO 306:2013, is at least 150° C., preferably more than 150° C., further preferably at least 175° C., more preferably at least 200° C.

This shaped article is an intermediate in the process for producing the three-dimensional target object, namely the product which is obtained by printing the print material and support material and from which the support material has to be separated in a next step, preferably by dissolution.

### EXAMPLES

### 1. Description of Raw Materials

PC1: is a commercially available copolycarbonate based on bisphenol A and bisphenol TMC, having an MVR of 18 cm³/10 min (330° C./2.16 kg, ISO 1133-1:2011) and a softening temperature (VST/B 120; ISO 306:2013) of 183° C. (Apec® 1895 from Covestro Deutschland AG). Lower bisphenol TMC content than PC2 and PC3.
PC2: is a commercially available copolycarbonate based on bisphenol A and bisphenol TMC, having an MVR of 8 cm³/10 min (330° C./2.16 kg, ISO 1133-1:2011) and a softening temperature (VST/B 120; ISO 306:2013) of 202° C. (Apec® 2097 from Covestro Deutschland AG).
PC3: is a commercially available copolycarbonate based on bisphenol A and bisphenol TMC, having an MVR of 5 cm³/10 min (330° C./2.16 kg, ISO 1133-1:2011) and a softening temperature (VST/B 120; ISO 306:2013) of 218° C. (Apec® DPI-9389 from Covestro Deutschland AG).
PC4: is a copolycarbonate based on bisphenol A and a siloxane having the general structural formula (1e), where R¹⁹=H, X=isopropylidene, R¹⁷=R¹⁸=methyl radical, p=1, m=3-4, n=30, having an MVR of 25 cm³/10 min (320° C./2.16 kg, ISO 1133-1:2011), having a softening temperature (VST/B 120; ISO 306:2013) of <150° C.
PC5: is a copolycarbonate based on bisphenol A and phthalimide (1c) with R³=phenyl, having a softening temperature (VST/B 120; ISO 306:2013) of >165° C. and less than 200° C.
PC6: is a copolycarbonate based on bisphenol A and phthalimide (1b) with R³=methyl, having a softening temperature (VST/B 120; ISO 306:2013) of >165° C. and less than 200° C.
PC7: is a commercially available polycarbonate based on bisphenol A having a partly branched structure, having an MVR of 2 cm³/10 min (300° C./1.2 kg, ISO 1133-1:2011) and a softening temperature (VST/B 50; ISO 306:2013) of 150° C. (Makrolon® WB1239 from Covestro Deutschland AG).
PC8: is a polycarbonate based on bisphenol A having partly branched structure, having an MVR of 12.6 cm³/10 min (300° C./1.2 kg, ISO 1133-1:2011) and a softening temperature (VST/B 50; ISO 306:2013) of 142° C.
PC9: is a commercially available copolycarbonate based on bisphenol A and bisphenol TMC, having an MVR of 45 cm³/10 min (330° C./2.16 kg, ISO 1133-1:2011) and a softening temperature (VST/B 120; ISO 306:2013) of 158° C. (Apec® 1695 from Covestro Deutschland AG).
PC10: is a commercially available copolycarbonate based on bisphenol A and bisphenol TMC, having an MVR of 24 cm³/10 min (330° C./2.16 kg, ISO 1133-1:2011) and a softening temperature (VST/B 120; ISO 306:2013) of 173° C. (Apec® 1795 from Covestro Deutschland AG).
PLA: polylactic acid is a commercially available thermoplastic polymer for use in 3D printing from Orbi-Tech.
PBT: is a commercially available polybutylene terephthalate from Lanxess (POCAN B 1300).
PA-12: Nylon-12 is a commercially available thermoplastic polymer for use in 3D printing with a recommended processing temperature of 270° C. from Orbi-Tech.
PC/PBT: is a commercially available elastomer-modified polycarbonate/polybutylene terephthalate blend based on a bisphenol A-based polycarbonate and polybutylene terephthalate, having an MVR of 16 cm³/10 min (260° C./5 kg, ISO 1133-1:2011) and a softening temperature (VST/B 120; ISO 306:2013) of 125° C.
PET: is a commercially available polyethylene terephthalate from Invista (XPURE® Polyester 4004/V004).
PC: is a commercially available polycarbonate based on bisphenol, having an MVR of 19 cm³/10 min (300° C./1.2 kg, ISO 1133-1:2011) and a softening temperature (VST/B 120; ISO 306:2013) of 148° C. (Makrolon® 2408 from Covestro Deutschland AG).
PC/ABS: is a commercially available polycarbonate/acrylonitrile-butadiene-styrene blend having an MVR of 18 cm³/10 min (260° C./5 kg, ISO 1133-1:2011) and a softening temperature (VST/B 120; ISO 306:2013) of 130° C. (Bayblend® T85XF from Covestro Deutschland AG).
PC/ABS FR: is a commercially available flame-retardant polycarbonate/acrylonitrile-butadiene-styrene blend having an MVR of 18 cm³/10 min (260° C./5 kg, ISO 1133-1:2011) and a softening temperature (VST/B 120; ISO 306:2013) of 136° C. (Bayblend® FR 331 ITV from Covestro Deutschland AG).
ABS: is a terpolymer consisting of the monomers acrylonitrile, 1,3-butadiene and of the company Ineos Styrolution Europe GmbH (Terluran® HI-10).
Durabio: is a biodegradable polycarbonate based on isosorbitol from Mitsubishi Chemical.
PEEK: is a commercially available polyetheretherketone from alt-intech.
Xylene: isomer mixture of o-, m- and para-xylene, ≥98.5% by weight, available from Sigma-Aldrich.
THF: tetrahydrofuran, ≥99.9% by weight, available from Sigma-Aldrich.
MIBK: methyl isobutyl ketone, 298.5% by weight, available from Sigma-Aldrich.
E3EP: ethyl 3-ethoxypropionate, 99% by weight, available from Sigma-Aldrich.
Solv. mixture: a solvent mixture of 5% by weight of 1,3,5-trimethylbenzene (mesitylene), 2.5% by weight of cumene, 30% by weight of 2-methoxy-1-methylethyl acetate, 15% by weight of 1,2,4-trimethylbenzene, 30% by weight of ethyl 3-ethoxypropionate and 17.5% by weight of naphtha.

### 2. Experimental Procedure

A study of the solubility of various print material/support material combinations in various solvents was conducted at room temperature (table 1). For this purpose, a material specimen plaque (about 1.0×1.0×0.2 cm, 0.3 g) of the potential print material (PLA, PBT, PA-12, PC/PBT, PC/ABS, PET, PC, ABS, Durabio, PEEK) was bonded to a specimen plaque (about 1.0×1.0×0.2 cm, 0.3 g) of the support material (polycarbonate copolymer, polycarbonate). The materials were bonded by application of one drop of methylene chloride between the specimen plaques. After the bonded part had dried sufficiently, the specimens were placed into 10 mL of solvent for 24 h. Subsequently, the result was evaluated (both qualitatively and quantitatively by weighing before and after). Although adhesion of the individual layers to one another is induced thermally in conventional 3D printing, the bonding of the specimen plaques by solvent was intended to simulate a situation under severe conditions. The influence of the solvent causes print material and support material to enter into a significantly stronger bond to one another since it can be assumed that the two materials are partially dissolved and the two polymers interdigitate to a greater degree at the bonding site. Under these conditions, mutual detachment is possible only through adequate dissolution of the support material. In this case, detachment of the support material in the later printed part is significantly easier to achieve in the case of merely thermal bonding.

In a further test series, some copolycarbonate/print material combinations chosen by random sampling were subjected to dissolution tests at elevated temperature (table 2). Table 2 states the temperature used for the respective solvent, as well as the time for complete dissolution of the support material.

In addition, a test series was conducted (table 3) in which ultrasound was used additionally. The dissolution tests were started at room temperature. During the dissolution operation, the temperature increased owing to the energy input by ultrasound to a final temperature of the THF of about 35° C. and of the xylene to about 35° C. to 50° C.

All the copolycarbonates used can additionally be printed as support materials.

### 3. Results

TABLE 1
Behavior of print material and support material under the influence of solvent
a

| | PC1 | | | | | PC2 | | | PC3 | | |
|---|---|---|---|---|---|---|---|---|---|---|---|
| | | | Solv. | | | | | Solv. | | | Solv. |
| | Xylene | THF | mixture | MiBK | E3EP | Xylene | THF | mixture | Xylene | THF | mixture |
| PLA | 1b | 1c | 2b | 2b | 2b | 1b | 1c | 1b | 1b | 1c | 1b |
| PBT | 1a | 1a | 2a | 2a | 2a | 1a | 1a | 1a | 1a | 1a | 1a |
| PA-12 | 1a | 1a | 1a | — | — | 1a | 1a | 1a | 1a | 1a | 1a |
| PC/PBT | 1a | 1a | 1a | — | — | 1a | 1a | 1a | 2a | 1a | 1a |
| PET | 1a | 1a | 1a | — | — | 2a | 1a | 1a | 1a | 1a | 1a |
| PC | 1c | 1c | 2c | 2c | 2c | 1c | 2c | 1c | 1c | 1c | 1b |
| ABS | 1c | 1c | 2c | 2c | 2c | 1c | 1c | 1c | 1c | 1c | 1c |
| PC/ABS | 1c | 1c | 1c | — | — | 1c | 1c | 1c | 1c | 1c | 1c |
| PC/ABS | 1c | 1c | 1c | — | — | 1c | 1c | 1c | 1c | 1c | 1c |
| FR | | | | | | | | | | | |
| Durabio | 2c | 1c | 2c | 2a | 2a | 1c | 1c | 1c | 1c | 1c | 1c |
| D5380AR | | | | | | | | | | | |
| Durabio | 2c | 1c | 2c | 2a | 2a | 1c | 1c | 1a | 1c | 1c | 1a |
| D7340AR | | | | | | | | | | | |
| PEEK | 2a | 2a | 1a | — | — | 1a | 1a | 1a | 1a | 1a | 1a |

b

| | PC4 | | | PC5 | | PC6 | |
|---|---|---|---|---|---|---|---|
| | Xylene | THF | Solv. mixture | Xylene | THF | Xylene | THF |
| PLA | 3b | 1c | 3b | 3b | 1c | 3b | 1c |
| PBT | 3a | 1a | 3a | 3a | 1a | 3a | 1a |
| PA-12 | 3a | 1a | 3a | 3a | 1a | 3a | 1a |
| PC/PBT | 3a | 1a | 3a | 3a | 1a | 3a | 1a |
| PET | 3a | 1a | 3a | 3a | 1a | 3a | 1a |
| PC/ABS | 3c | 1c | — | 3c | 3c | 3c | 3c |
| PC/ABS | 3c | 1c | — | 3c | 3c | 3c | 3c |
| FR | | | | | | | |

c

| | PC7 | | | PC8 | | |
|---|---|---|---|---|---|---|
| | Xylene | THF | Solv. mixture | Xylene | THF | Solv. mixture |
| PC | 3c | 3c | 3c | 3c | 2c | 3c |

d

PC10

| | PC9 | | | | Solv. | |
|---|---|---|---|---|---|---|
| | Xylene | Solv. mixture | THF | Xylene | mixture | THF |
| PBT | 3a | 2a | 1a | 3a | 3a | 1a |
| PA-12 | 3a | 2a | 1a | 3a | 3a | 1a |
| PC/PBT | 3a | 2a | 1a | 3a | 3a | 1a |
| PET | 3a | 3a | 1a | 3a | 3a | 1a |
| PC | 3c | 2c | 1c | 3c | 3b | 1c |
| ABS | 3c | 2c | 1c | 3c | 3c | 1c |
| PC/ABS | 3c | 2c | 1c | 3c | 3c | 1c |
| PC/ABS | 3c | 2c | 1c | 3c | 3c | 1c |
| FR | | | | | | |
| Durabio | 3c | 2c | 1c | 3c | 3c | 1c |
| D5380AR | | | | | | |
| Durabio | 3c | 2c | 1c | 3c | 3a | 1c |
| D7340AR | | | | | | |
| PEEK | 3a | 2a | 1a | 3a | 3a | 1a |

Key: support materials in the first line of the table, print materials in the first column of the table.
[1] support material fully dissolved;
[2] support material incompletely dissolved after 24 h;
[3] support material not dissolved;
[a] print material undamaged and dimensionally stable;
[b] print material hazy, but dimensionally stable;
[c] print material destroyed (e.g. cracked, embrittled, broken up, partly dissolved);
—: not tested
PC4 does not dissolve completely in most solvents, but breaks down into small pieces and can thus be separated from the print material (assessment “I”).
Combinations with the assessment “2c” (e.g. ABS as print material and PC1 as support material, solvent: MIBK) arc unsuitable both because the print material is destroyed in the chosen solvent and because it was possible to dissolve the support material only incompletely, if at all.
By contrast, combinations with a “1a” assessment are of excellent suitability since the support material can be dissolved completely in the chosen solvent and the print material remains undamaged. Examples of particularly suitable combinations of print material/support material are, according to table 1, for example, PEEK + PC2, PBT + PC2, PC/PBT + PC2 or PA-12 + PC3 (and others). The choice of solvent has a crucial influence on the suitability of combinations. The solvent mixture is suitable for dissolution of copolymers (PC2, PC3) having a high BPA-TMC content, but fails in the case of PC1 (assessment “2”).

According to the results, a particularly suitable combination is: PEEK or PC/PBT as print material and PC2 as support material when THF or xylene is used for later dissolution of the support material.

PEEK and PC1 to PC3 in particular, i.e. the copolycarbonates for use in accordance with the invention that have monomer units of the formula (1a), have a very similar processing temperature and all have particularly high stability under prolonged thermal stress. Many other good combinations can be identified in the table. Good combinations were subsequently tested at elevated temperature or with ultrasound and the time for dissolution of the support material was examined (table 2 and table 3).

The polycarbonate homopolymer is suitable neither as print material nor as support material since it becomes cracked and brittle in the dissolution operation, but does not dissolve or become detached. The copolycarbonates PC8 and PC9 that have a partly branched structure are likewise unsuitable as support materials. They do not dissolve in the solvents tested and have only haziness and embrittlement.

Only the copolycarbonate PC7 shows good dissolution characteristics in THF and moderate dissolution characteristics in xylene. By comparison with PC2, however, it dissolves much more slowly.

TABLE 2
Behavior of print material and support material under
the influence of solvent at elevated temperature. Time
until complete dissolution of the support material.

| | |
|---|---|
| PC2 | PC3 |

| | Xylene | THF | Xylene | THF |
|---|---|---|---|---|
| | (75-80° C.) | (50° C.) | (75-80° C.) | (50° C.) |
| PBT | 90 min | 75 min | 45 min | 25 min |
| PA-12 | 60 min | 60 min | 35 min | 25 min |
| PC/PBT | 110 min | 70 min | 45 min | 35 min |
| PET | 95 min | 75 min | 50 min | 35 min |
| PEEK | 40 min | 30 min | 50 min | 35 min |

Test parameters: THF = 50° C.; xylene = 75-80° C.; results as the average from double determination.

TABLE 3
Behavior of print material and support material under the influence of
solvent at rising temperature through ultrasound. Time until complete
dissolution of the support material.

| | PC2 | | | PC3 | | |
|---|---|---|---|---|---|---|
| | | | Solv. | | | Solv. |
| | Xylene | THF | mixture | Xylene | THF | mixture |
| PBT | 30 min | 15 min | 120 min | 15 min | 15 min | 45 min |
| PA-12 | 30 min | 20 min | 120 min | 20 min | 15 min | 80 min |
| PC/PBT | 20 min | 20 min | 85 min | 15 min | 15 min | 90 min |
| PET | 30 min | 15 min | 120 min | 15 min | 15 min | 80 min |
| PEEK | 30 min | 20 min | — | 15 min | 20 min | — |

Results as the average from double determination.

The tests conducted have shown that PEEK, PBT, PA-12, PC/PBT and PET are print materials that are suitable in principle, which can be used with bisphenol TMC-based copolycarbonates or the other copolycarbonates of high thermal stability used as support material in 3D printing, and that xylene, THF or the solvent mixture, especially THF and/or xylene, are suitable as solvents for dissolution of the bisphenol TMC-based copolymers. Using these solvents, the respective copolycarbonate can be dissolved without residue. In general, it took up to 24 h at room temperature for the support material to go completely into solution or for it to dissolve to such an extent that it became detached from the print material.

As well as bonding of the sample plaques of print material and support material with the aid of methylene chloride, these were also bonded by thermal means. For this purpose, one of the two materials in each case was heated briefly to about 400° C. with a hot air gun and the two sample plaques were subsequently pressed against one another until they had cooled down. The dissolution properties being studied were subsequently examined analogously to the above tests. The same dissolution behavior was found for the combinations specified.

The study of the solubility of the various print material/support material combinations at elevated temperature (table 2) showed that this not only increases the dissolution rate of the support material but also that, surprisingly, the print material is not attacked. At an elevated temperature of 50° C., both PC2 and PC3 dissolved within a maximum of 75 min. With a higher proportion of bisphenol TMC (PC3 versus PC2) in the copolycarbonate, it was possible to observe a rise in the dissolution rate.

As apparent from table 3, ultrasound treatment during the process of dissolution of the support material leads to a distinct increase in the dissolution rate. No effect of the ultrasound treatment on the print material was detected.

1.-11. (canceled)

12. A process for producing a three-dimensional target object by means of fused deposition modeling using a support material, wherein a solvent is used to remove the support material, characterized in that the support material used is a composition based on a copolycarbonate having a Vicat temperature (VST/B120), determined according to ISO 306:2013, of at least 150° C.,
and wherein
the copolycarbonate contains one or more monomer units
of the formula (1a) 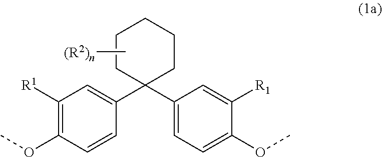
in which
R¹ is hydrogen or a C₁- to C₄-alkyl radical,
R² is a C₁- to C₄-alkyl radical,
n is 0, 1, 2 or 3,
(1b), (1c) and/or (1d) 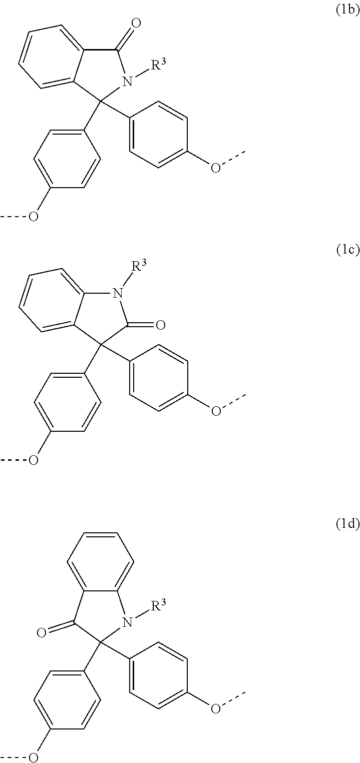
in which
R³ is a C₁- to C₄-alkyl radical, aralkyl radical or aryl radical,
and/or
of the formula (1e) 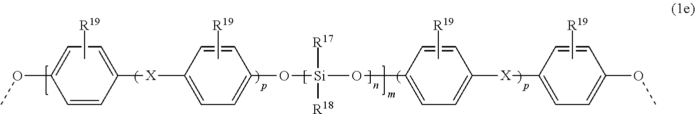
in which
R¹⁹ is hydrogen, Cl, Br or a C₁- to C₄-alkyl radical,
R¹⁷ and R¹⁸ are the same or different and are each independently an aryl radical, a C₁- to C₁₀-alkyl radical or a C₁- to C₁₀-alkylaryl radical, and where
X is a single bond, —CO—, —O—, a C₁- to C₆-alkylene radical, a C₂- to C₅-alkylidene radical, a C₅- to C₁₂-cycloalkylidene radical or a C₆- to C₁₂-arylene radical, which may optionally be fused to further aromatic rings containing heteroatoms,
n is a number from 1 to 500,
m is a number from 1 to 10,
p is 0 or 1,
and wherein the print material used is a polyester, a polyamide, a PC/polyester blend and/or a polyaryl ether ketone,
and wherein THF is used to remove the support material when the Vicat temperature (VST/B120), determined according to ISO 306:2013, is below 175° C. and/or a copolycarbonate having monomer units of the formulae (1b), (1c), (1d) and/or (1e) is used.

13. The process as claimed in claim 12, characterized in that the copolycarbonate contains one or more monomer units of the formula (1a) 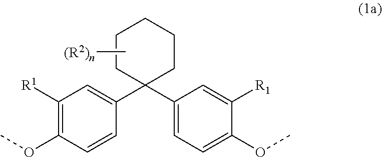
in which
R¹ is hydrogen or a C₁- to C₄-alkyl radical,
R² is a C₁- to C₄-alkyl radical,
n is 0, 1, 2 or 3.

14. The process as claimed in claim 12, characterized in that the copolycarbonate has been prepared from the monomers 1,1-bis(4-hydroxyphenyl)-3,3,5-trimethylcyclohexane and 2,2-bis(4-hydroxyphenyl)propane.

15. The process as claimed in claim 12, characterized in that the copolycarbonate has a Vicat temperature (VST/B120), determined according to ISO 306:2013, of at least 200° C.

16. The process as claimed in claim 12, characterized in that the copolycarbonate contains one or more monomer units of the formula (1b), (1c) and/or (1d) 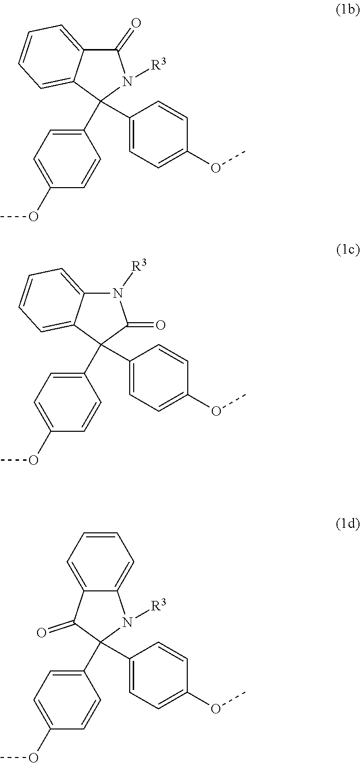
in which
R³ is a C₁- to C₄-alkyl radical, aralkyl radical or aryl radical,
and THF is used as solvent for removal of the support material.

17. The process as claimed in claim 12, characterized in that the copolycarbonate contains one or more monomer units of the formula (1e) 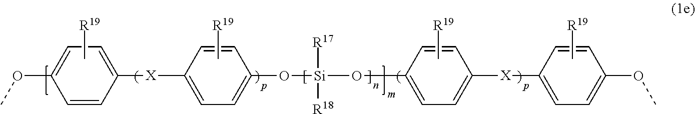
in which
R¹⁹ is hydrogen, Cl, Br or a C₁- to C₄-alkyl radical,
R¹⁷ and R¹⁸ are the same or different and are each independently an aryl radical, a C₁- to C₁₀-alkyl radical or a C₁- to C₁₀-alkylaryl radical, and where
X is a single bond, —CO—, —O—, a C₁- to C₆-alkylene radical, a C₂- to C₅-alkylidene radical, a C₅- to C₁₂-cycloalkylidene radical or a C₆- to C₁₂-arylene radical, which may optionally be fused to further aromatic rings containing heteroatoms,
n is a number from 1 to 500,
m is a number from 1 to 10,
p is 0 or 1,
and THF is used as solvent for removal of the support material.

18. The process as claimed in claim 12, characterized in that the support material is removed at a solvent temperature of 50 to 80° C.

19. The process as claimed in claim 12, characterized in that the support material is removed under the action of ultrasound.

20. The process as claimed in claim 12, characterized in that the print material used is a material having a processing temperature of at least 330° C.

21. A shaped article having
a) a multitude of layers comprising copolycarbonate, comprising one or more monomer units of the formulae (1a), (1b), (1c), (1d) 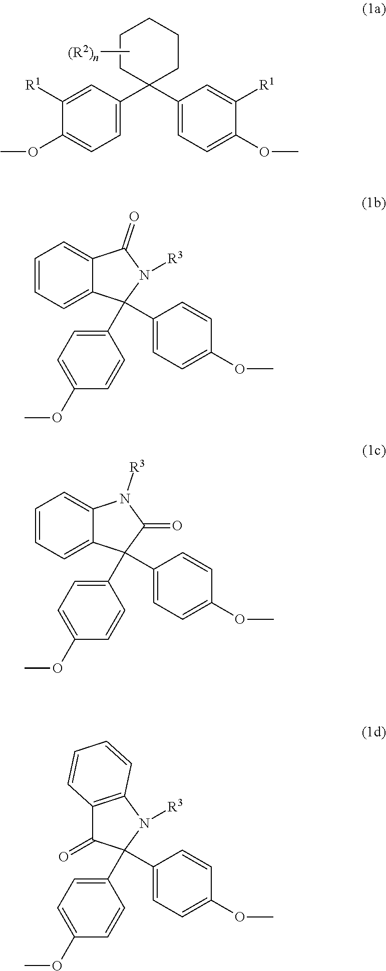
in which
R¹ is hydrogen or a C₁- to C₄-alkyl radical,
R² is a C₁- to C₄-alkyl radical,
n is 0, 1, 2 or 3,
R³ is a C₁- to C₄-alkyl radical, aralkyl radical or aryl radical,
and/or one or more of the monomer units (1e) 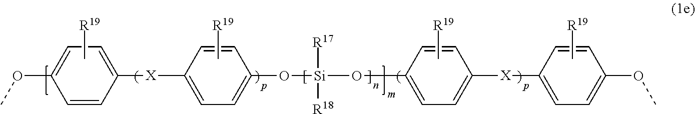
in which
R¹⁹ is hydrogen, Cl, Br or a C₁- to C₄-alkyl radical,
R¹⁷ and R¹⁸ are the same or different and are each independently an aryl radical, a C₁- to C₁₀-alkyl radical or a C₁- to C₁₀-alkylaryl radical, and where
X is a single bond, —CO—, —O—, a C₁- to C₆-alkylene radical, a C₂- to C₅-alkylidene radical, a C₅- to C₁₂-cycloalkylidene radical or a C₆- to C₁₂-arylene radical, which may optionally be fused to further aromatic rings containing heteroatoms,
n is a number from 1 to 500,
m is a number from 1 to 10,
p is 0 or 1,
and
b) a multitude of layers comprising a polyester, a polyamide, a PC/polyester blend and/or a polyaryl ether ketone.

22. The process as claimed in claim 12 or the shaped article as claimed in claim 21, wherein the polyester of the print material is a PBT and/or a PET.
